(19) United States
(12) Patent Application Publication
(10) Pub. No.: US 2018/0340954 A1
(43) Pub. Date: Nov. 29, 2018

(54) ROTATION SPEED DETECTION DEVICE

(71) Applicant: DENSO CORPORATION, Kariya-city, Aichi-pref. (JP)

(72) Inventor: Hirotsugu ISHINO, Kariya-city (JP)

(21) Appl. No.: 15/762,780

(22) PCT Filed: Sep. 21, 2016
(86) PCT No.: PCT/JP2016/077770

§ 371 Date: Mar. 23, 2018

(30) Foreign Application Priority Data
Oct. 7, 2015 (JP) 2015-199248

(51) Int. Cl. G01P 3/02

(52) U.S. Cl. CPC G01P 3/02

(57) ABSTRACT

A rotation speed detection device includes a blade detection sensor located in a housing of a turbocharger and that outputs an output voltage that fluctuates according to an approaching of a blade of a compressor wheel to the blade detection sensor and a separation of the blade from the blade detection sensor, and a sensor circuit to binarize an output signal of the blade detection sensor into a high signal and a low signal and to output the signals. The sensor circuit includes a low pass filter to cut off a high frequency component of the output signal by an analog filter or a digital filter, a high pass filter to cut off a low frequency component of the output signal by a digital filter, and a control unit to increase a cut-off frequency of the high pass filter in accordance with an increase in rotation speed of the turbocharger.

### CROSS REFERENCE TO RELATED APPLICATION

This application is based on the Japanese Patent Application No. 2015-199248 filed on Oct. 7, 2015, the disclosure of which is incorporated herein by reference.

### TECHNICAL FIELD

The present disclosure relates to a rotation speed detection device which detects a rotation speed of a turbocharger mounted to an engine for a vehicle travelling, and specifically relates to a technology detecting a rotation state of a blade located at a compressor wheel.

### BACKGROUND ART

A rotation speed detection device disclosed in Patent Literature 1 is known for a technology that senses a rotation state of a blade located at a compressor wheel.

The rotation speed detection device in Patent Literature 1 discloses a technology that senses the rotation state of the blade by using a blade detection sensor. The blade detection sensor is mounted to an intake gas compressor. The blade detection sensor outputs an output voltage that fluctuates according to a repeat of an approaching of the blade of the compressor wheel to the blade detection sensor and a separation of the blade from the blade detection sensor. Hereafter, a frequency of the approaching and the separation of the blade in an output signal of the blade detection sensor will be described as a blade frequency.

### PRIOR ART LITERATURES

### Patent Literature

Patent Literature 1: JP2013-234591A

### SUMMARY OF INVENTION

A most-approaching distance that each blade is closest to the blade detection sensor may vary due to a shaft shift without being constant.

The shaft shift will be described. A turbocharger includes a shaft that transmits a rotation of a turbine wheel to the compressor wheel. The shaft is rotatably supported by a bearing. The bearing separates the shaft from the housing by an oil. The shaft can rotate at a high speed. Thus, it is possible that the shaft is shifted from an initial position and rotates relative to the housing. A state where the shaft is shifted and rotates is referred to as the shaft shift.

When the most-approaching distance varies due to the shaft shift, an increasing and decreasing width of an output voltage of the blade detection sensor is increased by the shaft shift. When the increasing and decreasing width of the output voltage exceeds a threshold, an error occurs in a cycle measurement, and a detection error of the rotation speed occurs.

The rotation speed detection device may receive a low frequency noise.

For example, a road heater that warms a road surface is located at a road in a cold zone. The road heater generally operates at a low frequency of a commercial power supply such as 50 Hz or 60 Hz. Thus, when a vehicle travels on the road at which the road heater is located, the vehicle receives a magnetic affection of the low frequency. The rotation speed detection device may receive the low frequency noise, and the detection error of the rotation speed may occur due to the low frequency noise.

It is an object of the present disclosure to provide a rotation speed detection device which can detect a rotation speed of a turbocharger without generating a detection error.

According to an aspect of the present disclosure, the rotation speed detection device includes a blade detection sensor located in a housing of an intake gas compressor of a turbocharger that compresses an intake gas and supplies the intake gas to an engine for a vehicle travelling and the blade detection sensor to output an output voltage that fluctuates according to an approaching of a blade of a compressor wheel that rotates in the housing to the blade detection sensor and a separation of the blade from the blade detection sensor, and a sensor circuit to binarize an output signal of the blade detection sensor into a high signal and a low signal and to output the high signal and the low signal. The sensor circuit includes a low pass filter to cut off a high frequency component of the output signal of the blade detection sensor by an analog filter or a digital filter, a high pass filter to cut off a low frequency component of the output signal of the blade detection sensor by a digital filter, and a control unit to increase a cut-off frequency of the high pass filter in accordance with an increase in rotation speed of the turbocharger and to decrease the cut-off frequency of the high pass filter in accordance with a decrease in rotation speed of the turbocharger.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic diagram showing an outline of a rotation speed detection device;

FIG. 2 is a diagram showing a sensor circuit;

FIG. 3 is a graph showing a switching of a cut-off frequency;

FIG. 4 is a graph showing waveforms of an input signal and an output signal of a sub-HPF;

FIG. 5 is a graph showing output waveforms of the sub-HPF and a HPF;

FIG. 6 is a diagram showing an IIR filter;

FIG. 7 includes (a) and (b), (a) is a graph showing the output waveform of the HPF when a history data is not reset in a case where the cut-off frequency is switched, and (b) is a graph showing the output waveform of the HPF when the history data is reset in a case where the cut-off frequency is switched;

FIG. 8 is a diagram showing the sensor circuit;

FIG. 9 is a graph showing a waveform of an output signal of the HPF;

FIG. 10 is a diagram showing the sensor circuit;

FIG. 11 is a diagram showing the sensor circuit;

FIG. 12 is a diagram showing the sensor circuit;

FIG. 13 includes (a) and (b), (a) is a graph showing a binarization waveform of the output waveform of the HPF, a binarization waveform output from a signal continuation unit and a binarization waveform that is corrected, before and after the cut-off frequency is switched, and (b) is a graph showing waveforms when an overlap between a binarization waveform output by a binarization unit and the binarization waveform output from the signal continuation unit reaches a predetermined ratio; and

FIG. 14 is a schematic diagram showing the outline of the rotation speed detection device.

### DESCRIPTION OF EMBODIMENTS

Embodiments of the present disclosure will be described hereafter referring to drawings. In addition, the embodiments are examples of the present disclosure, and the present disclosure is not limited to the embodiments.

### First Embodiment

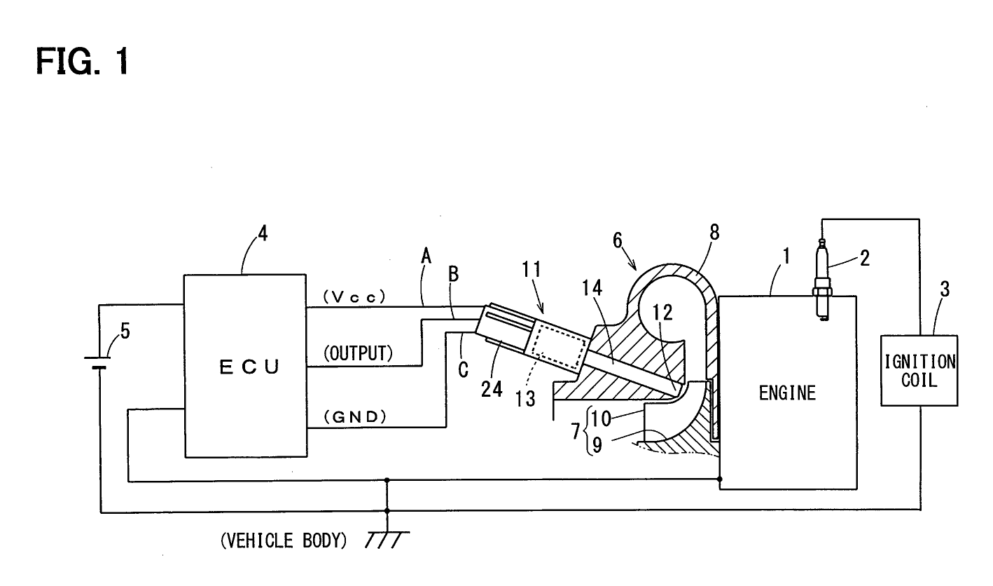

Referring to FIGS. 1 to 13, a first embodiment of the present disclosure will be described.

An engine 1 that is mounted to a vehicle for a travel is an internal combustion engine that executes a combustion of a fuel to generate a rotation output.

A type of the engine 1 is not limited. However, as an example for understanding, FIG. 1 shows a spark ignition engine that a mixed gas ignites by a spark ignition. According to the present embodiment, the engine 1 includes a spark plug 2 that executes the spark ignition and an ignition coil 3 that generates a high voltage at the spark plug 2.

FIG. 1 only shows a secondary coil of the ignition coil 3. A positive terminal of the secondary coil is connected with a center electrode of the spark plug 2. A negative terminal of the secondary coil is connected with a vehicle body.

An ECU 4 controls an operation state of the engine 1. The ECU 4 is an engine control unit that is provided with a computer.

The ECU 4 receives a power supply from a vehicle battery 5. The ECU 4 includes a stabilization power source that converts a battery voltage into an operation voltage of the computer.

The engine 1 is mounted to a turbocharger that compresses an intake gas.

A basic constitution of the turbocharger is known. The turbocharger includes an exhaust turbine that is driven by an exhaust gas of the engine 1 and an intake-gas compressor 6 that is driven by the exhaust turbine and compresses the intake gas suctioned into the engine 1.

The exhaust turbine includes a turbine wheel that is rotatably driven by the exhaust gas of the engine 1 and a turbine housing that is a swirl shape and receives the turbine wheel.

The intake-gas compressor 6 includes a compressor wheel 7 that is driven by a rotation force of the turbine wheel and compresses the intake gas and a compressor housing 8 that is a swirl shape and receives the compressor wheel 7.

The turbine wheel and the compressor wheel 7 are connected with each other through a shaft. The shaft is rotatably supported by a center housing located between the turbine housing and the compressor housing 8. The shaft can rotate at a high speed.

A basic constitution of the compressor wheel 7 is known. The compressor wheel 7 includes a hub 9 that is rotatably supported and plural blades 10 that are integrally provided and are located at an outer peripheral surface of the hub 9.

The hub 9 is a substantially conical shape and is connected with an end part of the shaft.

Each of the blades 10 is a bent thin plate shape, and extends from the outer peripheral surface of the hub 9 outward in a radial direction. As an example for understanding, the blades 10 include two types of blades where blade areas are different. The blades 10 include large blades that have a relatively large blade area and small blades that have a relatively small blade area. The large blades and the small blades are alternately arranged in a rotational direction at a substantially same interval.

(First Technical Feature)

A rotation speed detection device 11 that detects a rotation speed of the turbocharger is assembled to the intake-gas compressor 6.

The ECU 4 calculates an intake-gas quantity of the engine 1 based on the rotation speed of the turbocharger calculated from an output signal of the rotation speed detection device 11.

The rotation speed detection device 11 is integrally constituted by a blade detection sensor 12 that senses passings of tip ends of the blades 10 without being in contact with the blades 10 and a sensor circuit 13 that binarizes an output signal of the blade detection sensor 12 into a high signal and a low signal and outputs the high signal and the low signal.

The rotation speed detection device 11 is connected with the ECU 4 through a lead wire. The lead wire that connects the rotation speed detection device 11 with the ECU 4 includes a power lead A that applies an operation voltage from the stabilization power source in the ECU 4 to the sensor circuit 13, a signal lead B that applies an output signal of the sensor circuit 13 to the ECU 4 and an earth lead C that connects the stabilization power source in the ECU 4 with a ground.

The blade detection sensor 12 is located at a tip end of a probe 14. The probe 14 is a columnar shape. When the rotation speed detection unit 11 is assembled to the compressor housing 8, the blade detection sensor 12 is located at a position where the blade detection sensor 12 can sense an approaching of the blades 10 and a separation of the blades 10.

The blade detection sensor 12 is a noncontact sensor that an output voltage of the noncontact sensor fluctuates according to the approaching of the blades 10 to the blade detection sensor 12 and the separation of the blades 10 from the blade detection sensor 12.

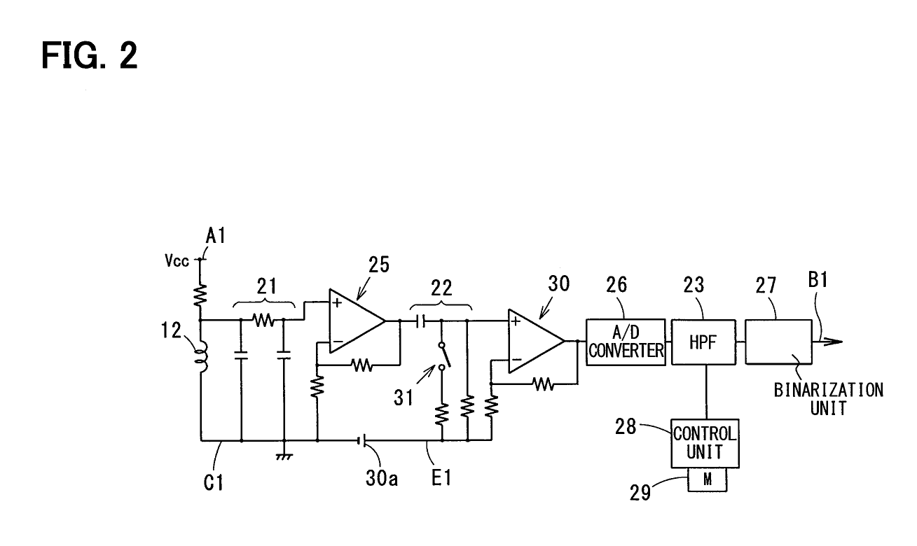

According to the present embodiment, an eddy current sensor that has a known constitution is used as an example of the blade detection sensor 12. FIG. 2 only shows a pickup coil of the eddy current sensor. In addition, the blade detection sensor 12 is not limited to the eddy current sensor, and may be other noncontact sensors.

According to the first embodiment, the tip end of the probe 14 is directly exposed to an inner space of the compressor housing 8. The blade detection sensor 12 located at the tip end of the probe 14 is located to face the compressor wheel 7 via a space gap. The output voltage of the blade detection sensor 12 fluctuates every time that an edge of the blade 10 approaches a tip of the blade detection sensor 12 or the edge of the blade 10 separates from the tip of the blade detection sensor 12.

Specifically, when the compressor wheel 7 rotates at one rotation, the output voltage of the blade detection sensor 12 fluctuates according to a total number of the blades 10. In other words, when the compressor wheel 7 rotates, the blade detection sensor 12 outputs a blade detection frequency according to the rotation speed of the turbocharger.

As shown in FIG. 2, the sensor circuit 13 includes a LPF (low pass filter) 21 constituted by an analog filter, a sub-HPF (sub high pass filter) 22 constituted by an analog filter and a HPF (high pass filter) 23 constituted by a digital filter.

As shown in FIG. 2, a notation A1 indicates a power line. The power line A1 is electrically connected with the power lead A through a connector 24.

As shown in FIG. 2, a notation B1 indicates a signal line. The signal line B1 is electrically connected with the signal lead B through the connector 24.

As shown in FIG. 2, a notation C1 indicates an earth line. The earth line C1 is electrically connected with the earth lead C through the connector 24.

As shown in FIG. 2, the LPF 21 is a CR filter that includes a condenser and a resistor. It is not limited to an order number of a slope setting of a filter characteristic. A notation 25 indicates an operational amplifier that is used to amplify a signal and is located at a rear region of the LPF 21.

The LPF 21 cuts off a high frequency component, and a cut-off frequency is properly set according to a high frequency noise that is required to be removed. As an example for understanding, the cut-off frequency of the LPF 21 is set to be about 15 kHz.

According to the first embodiment, the cut-off frequency of the LPF 21 is set to a frequency higher than a cut-off frequency of the HPF 23 to be readily understood. However, it is not limited.

Specifically, the cut-off frequency of the LPF 21 may be set to a frequency (e.g., 5 kHz) lower than the cut-off frequency of the HPF 23. In other words, a cut region of the LPF 21 and a cut region of the HPF 23 are intendedly made to overlap each other, and a frequency range passing a filter may be set to be narrow. Only a frequency component necessary to sense the rotation speed may be remained while other frequency components are cut off.

According to the first embodiment, the LPF 21 is constituted by an analog filter. However, it is not limited, and the LPF 21 may be constituted by a digital filter.

According to the first embodiment, the cut-off frequency of the LPF 21 is fixed. However, the cut-off frequency of the LPF 21 may be changed according to a variation of the rotation speed of the turbocharger. Specifically, the cut-off frequency of the LPF 21 may be configured to increase in accordance with an increase in rotation speed of the turbocharger and to decrease in accordance with a decrease in rotation speed of the turbocharger. When the cut-off frequency of the LPF 21 is changed, the cut-off frequency of the LPF 21 may be switched to plural levels according to the rotation speed of the turbocharger or may be continuously changed according to the rotation speed of the turbocharger.

The HPF 23 cuts off a low frequency component.

The sensor circuit 13 further includes an A/D converter 26, a binarization unit 27 and a control unit 28.

The A/D converter 26 is a converter that converts an increasing and decreasing signal of a voltage into a digital signal and applies the digital signal to the HPF 23.

The binarization unit 27 is a converter that binarizes an output signal of the HPF 23 into a high signal and a low signal and outputs the high signal and the low signal.

The HPF 23 is constituted by a fourth-order IIR filter. The above order number of the HPF 23 is an example, and an order number other than four may be used in the HPF 23.

The IIR filter is an infinite impulse response filter that is known and switches the cut-off frequency by executing a change of a filter constant of a feedback and a change of a filter constant of a feed forward.

The control unit 28 executes a switching of the cut-off frequency of the HPF 23.

The control unit 28 is a digital signal processor including a storage device and executes the switching of the cut-off frequency of the HPF 23 according to the rotation speed of the turbocharger.

Specifically, the control unit 28 is configured to increase the cut-off frequency of the HPF 23 in accordance with an increase in rotation speed of the turbocharger and to decrease the cut-off frequency of the HPF 23 in accordance with a decrease in rotation speed of the turbocharger.

The rotation speed of the turbocharger is proportional to an output frequency of the blade detection sensor 12. The control unit 28 calculates the rotation speed of the turbocharger from the output frequency of the blade detection sensor 12.

A switching control of the HPF 23 executed by the control unit 28 will be described.

The control unit 28 according to the present embodiment switches the cut-off frequency of the HPF 23 to three levels according to the rotation speed of the turbocharger.

Specifically, when the compressor wheel 7 is in a low speed rotation, the control unit 28 sets the cut-off frequency of the HPF 23 to a predetermined frequency (refer to a low fc).

When the compressor wheel 7 is in a medium speed rotation, the control unit 28 sets the cut-off frequency of the HPF 23 to a predetermined frequency (refer to a medium fc).

When the compressor wheel 7 is in a high speed rotation, the control unit 28 sets the cut-off frequency of the HPF 23 to a predetermined frequency (refer to a high fc).

Specified values of the low fc, the medium fc and the high fc are not limited. However, an example for understanding will be described. According to the present embodiment, the low fc is set to 0.9 kHz, the medium fc is set to 6.93 kHz, and the high fc is set to 11.83 kHz.

A switching timing of the cut-off frequency relative to the rotation speed of the turbocharger includes a hysteresis to prevent a hunting.

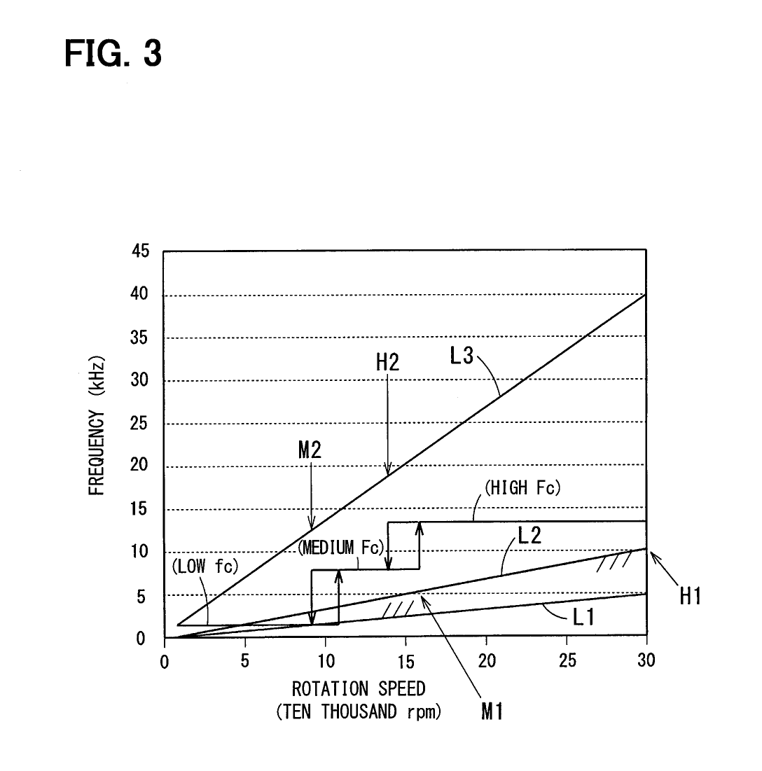

Referring to FIG. 3, a specified example will be described.

When the rotation speed of the turbocharger increases to 110,000 rpm from a state where the cut-off frequency of the HPF 23 is set to the low fc, the control unit 28 switches the cut-off frequency of the HPF 23 from the low fc to the medium fc.

When the rotation speed of the turbocharger decreases to 90,000 rpm from a state where the cut-off frequency of the HPF 23 is set to the medium fc, the control unit 28 switches the cut-off frequency of the HPF 23 from the medium fc to the low fc.

Similarly, when the rotation speed of the turbocharger increases to 160,000 rpm from a state where the cut-off frequency of the HPF 23 is set to the medium fc, the control unit 28 switches the cut-off frequency of the HPF 23 from the medium fc to the high fc.

When the rotation speed of the turbocharger decreases to 150,000 rpm from a state where the cut-off frequency of the HPF 23 is set to the high fc, the control unit 28 switches the cut-off frequency of the HPF 23 from the high fc to the medium fc.

(First Effect)

The rotation speed detection device 11 cuts off the high frequency component of the output signal of the blade detection sensor 12 by the LPF 21. Thus, a malfunction that a detection error occurs due to the high frequency noise including an ignition noise can be prevented.

The rotation speed detection device 11 cuts off the low frequency component of the output signal of the blade detection sensor 12 by the HPF 23. Thus, a malfunction that a detection error occurs due to a low frequency noise generated by a load heater can be prevented.

A shaft vibration frequency included in the output voltage of the blade detection sensor 12 is lower than the blade detection frequency. Specifically, for example, when the total number of the blades 10 is n, the shaft vibration frequency is in a relation that the blade detection frequency/n. According to the present embodiment, the shaft vibration frequency is a frequency that increases or decreases according to a shaft shift.

As the above description, the rotation speed detection device 11 according to the first embodiment changes the cut-off frequency of the HPF 23 according to the rotation speed of the turbocharger. Thus, the rotation speed detection device 11 can cut off the shaft vibration frequency by the HPF 23 without cutting off the blade detection frequency varying according to the rotation speed. In other words, the rotation speed detection device 11 can cut off the shaft vibration frequency varying according to an increasing and decreasing of the rotation speed from the output voltage of the blade detection sensor 12. Thus, an increasing and decreasing variation of the output voltage due to the shaft shift can be suppressed, and a malfunction that the detection error occurs due to the shaft shift can be prevented.

(Second Technical Feature)

The control unit 28 switches the cut-off frequency of the HPF 23 to two or more levels according to the rotation speed of the turbocharger. According to the present embodiment, the control unit 28 switches the cut-off frequency of the HPF 23 to three levels.

(Second Effect)

As the above description, the control unit 28 switches the cut-off frequency of the HPF 23 by switching a filter constant of the HPF 23. Thus, a digital filter with a high order (according to the present embodiment, fourth order) is used while the control unit 28 can instantly switch the cut-off frequency only by a switching of the filter constant.

(Third Technical Feature)

Among plural cut-off frequencies that are switched at the HPF 23, the low fc that is the lowest frequency is set to a frequency where the rotation speed of the turbocharger can be detected when the engine 1 is in an idle operation state.

Specifically, as the above description, the low fc is set to 0.9 kHz.

(Third Effect)

It is difficult to detect the rotation speed of the turbocharger in the idle operation state.

Since the low fc is established as the above description, an affection of a splitter where an output waveform of the blade detection sensor 12 in the idle operation state increases or decreases can be reduced.

Specifically, since the large blade and the small blade alternately pass the tip of the blade detection sensor 12, the HPF 23 repeatedly receives a high wave amplitude and a low wave amplitude. In this case, wave amplitudes of the blade detection frequency can be unified when the blade detection frequency passes through the HPF 23.

Thus, a detection accuracy of the rotation speed of the turbocharger in the idle operation state can be improved. In other words, the rotation speed detection device 11 can accurately detect the rotation speed of the turbocharger in the idle operation state. Thus, The ECU 4 can detect an intake gas quantity that is a quantity of the intake gas supplied to the engine 1 with a high accuracy, based on the blade detection frequency output by the rotation speed detection device 11.

(Fourth Technical Feature)

At least a part of the cut-off frequencies that are switched at the HPF 23 is set by using a following frequency setting technology. Specifically, according to the first embodiment, the medium fc and the high fc are set by the following frequency setting technology.

The medium fc is equivalent to an example of a predetermined cut-off frequency.

In a coverage of the medium fc relative to the rotation speed of the turbocharger, an upper limit of the rotation speed of the turbocharger is referred to as a medium fc upper-limit rotation speed M1. According to the present embodiment, an example of the medium fc upper-limit rotation speed M1 is 160,000 rpm.

In the coverage of the medium fc relative to the rotation speed of the turbocharger, a lower limit of the rotation speed of the turbocharger is referred to as a medium fc lower-limit rotation speed M2. According to the present embodiment, an example of the medium fc lower-limit rotation speed M2 is 90,000 rpm.

A frequency (refer to a line L2 in FIG. 3) that is twice as a frequency (refer to a line L1 in FIG. 3) corresponding to the rotation speed of the turbocharger at the medium fc upper-limit rotation speed M1 is referred to as a medium fc upper-limit frequency. Specifically, according to the present embodiment, an example of the medium fc upper-limit frequency is about 5 kHz.

The output frequency (refer to a line L3 in FIG. 3) of the blade detection sensor 12 at the medium fc lower-limit rotation speed M2 is referred to as a medium fc lower-limit frequency. Specifically, according to the present embodiment, an example of the medium fc lower-limit frequency is about 12 kHz.

The medium fc is set to a frequency between the medium fc upper-limit frequency and the medium fc lower-limit frequency. Specifically, as the above description, the medium fc is set to 6.93 kHz.

The high fc is also equivalent to an example of a predetermined cut-off frequency.

In a coverage of the high fc relative to the rotation speed of the turbocharger, an upper limit of the rotation speed of the turbocharger is referred to as a high fc upper-limit rotation speed H1. According to the present embodiment, an example of the high fc upper-limit rotation speed H1 is 300,000 rpm.

In the coverage of the high fc relative to the rotation speed of the turbocharger, a lower limit of the rotation speed of the turbocharger is referred to as a high fc lower-limit rotation speed H2. According to the present embodiment, an example of the high fc lower-limit rotation speed H2 is 150,000 rpm.

A frequency that is twice as a frequency corresponding to the rotation speed of the turbocharger at the high fc upper-limit rotation speed H1 is referred to as a high fc upper-limit frequency. Specifically, according to the present embodiment, an example of the high fc upper-limit frequency is about 10 kHz.

The output frequency of the blade detection sensor 12 at the high fc lower-limit rotation speed H2 is referred to as a high fc lower-limit frequency. Specifically, according to the present embodiment, an example of the high fc lower-limit frequency is about 18 kHz.

The high fc is set to a frequency between the high fc upper-limit frequency and the high fc lower-limit frequency. Specifically, as the above description, the high fc is set to 11.83 kHz.

(Fourth Effect)

Since the cut-off frequency is set to a frequency higher than a frequency twice as the frequency corresponding to the rotation speed of the turbocharger when the HPF 23 with fourth-order is used, an increasing and decreasing of the output voltage due to an affection of the shaft shift can be reduced to one in ten.

Since the cut-off frequency is set to a frequency lower than the output frequency of the blade detection sensor 12, the frequency component necessary to sense the rotation speed is maintained.

(Fifth Technical Feature)

The control unit 28 has a blade-number processing function that increases the cut-off frequency of the HPF 23 in accordance with an increase in total number of the blades 10 input from an external of the control unit 28.

The storage device of the control unit 28 is provided with a nonvolatile memory (M) 29 that is a rewritable ROM.

In addition, an example of the nonvolatile memory 29 is an EEPROM (registered trademark).

The nonvolatile memory 29 previously stores a map or a calculation formula which indicates a relationship between the low fc, the medium fc and the high fc relative to the total number of the blades 10.

In an initial setting before a shipment of the vehicle, a tool of the initial setting sends an instruction of the total number of the blades 10 to the control unit 28. Then, the control unit 28 sets the low fc, the medium fc and the high fc according to the total number of the blades 10 by the blade-number processing function.

(Fifth Effect)

As the above description, a development cost of the rotation speed detection device 11 corresponding to the total number of the blades 10 can be suppressed. Specifically, a development cost of an IC package including the control unit 28 can be suppressed.

(Sixth Technical Feature)

According to the present embodiment, as the above description, the rotation speed detection device 11 uses the IIR filter as the HPF 23.

(Sixth Effect)

It is known that a FIR filter (finite impulse response filter) that is different from the IIR filter is used as a digital filter. An operation speed of the IIR filter is higher than an operation speed of the FIR filter. Since the IIR filter uses a capacity of a memory less than that used by the FIR filter, a memory space can be reduced.

(Seventh Technical Feature)

The earth line C1 of the sensor circuit 13 is isolated from the engine 1 and the vehicle body. Specifically, the earth line C1 is electrically separated from the engine 1 and the vehicle body.

(Seventh Effect)

As the above description, a voltage of the earth line C1 is not electrically affected by the vehicle body. Thus, a noise of the power line A1 and a noise of the signal line B1 can be suppressed.

(Eighth Technical Feature)

The sensor circuit 13 includes the sub-HPF 22 constituted by an analog filter. The sub-HPF 22 cuts off a frequency component lower than that cut off by the HPF 23. In other words, a cut-off frequency of the sub-HPF 22 is set to be lower than the cut-off frequency of the HPF 23.

Specifically, the sub-HPF 22 is a CR filter that includes a condenser and a resistor. It is not limited to an order number of a slope setting of a filter characteristic. A notation 30 indicates an operational amplifier that is used to amplify a signal and is located at a rear region of the sub-HPF 22. A notation 30a in FIG. 2 indicates a reference power source that outputs a reference voltage E1 (e.g., 2.0V) of the operational amplifier 30.

(Eighth Effect)

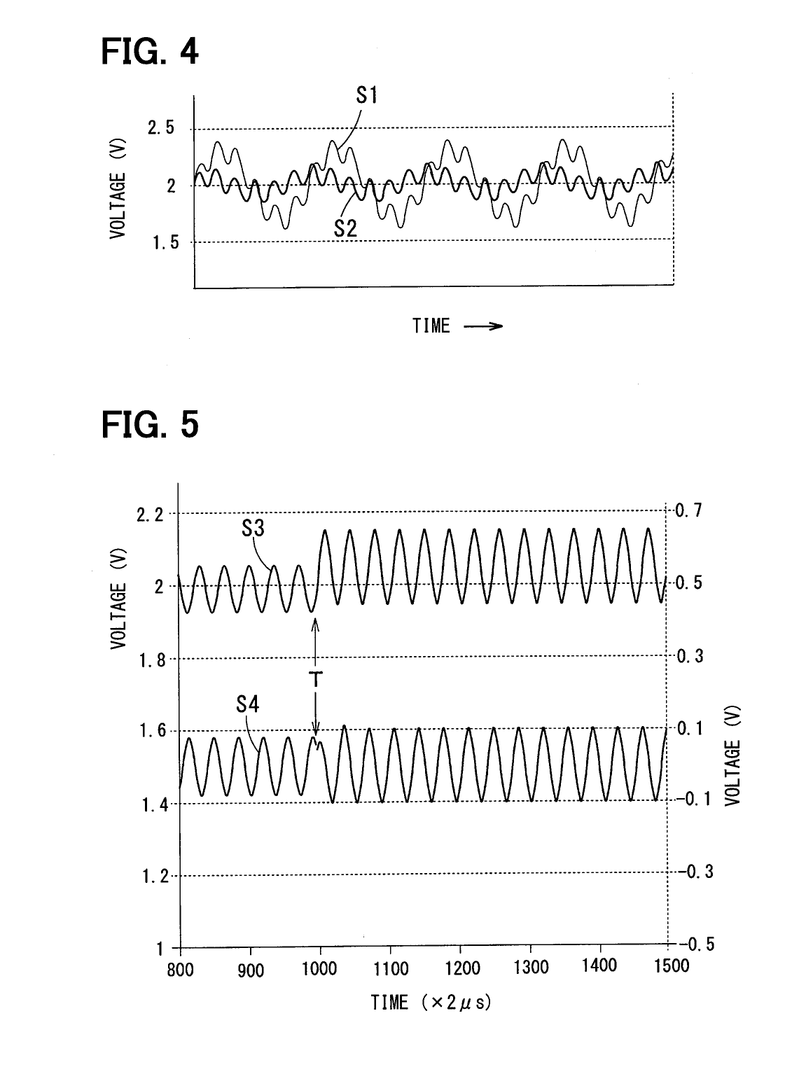

When the eighth technical feature is not used, it is possible that a signal before being input to the A/D converter 26 fluctuates due to a frequency lower than the cut-off frequency of the HPF 23 by the shaft shift as a signal S1 shown in FIG. 4.

When the eighth technical feature is used to provide the sub-HPF 22, an excessive variation of the signal due to the frequency lower than the cut-off frequency of the HPF 23 can be suppressed as a signal S2 shown in FIG. 4.

Thus, a load of the A/D converter 26 can be suppressed. Alternatively, since it is unnecessary that a gain of the signal input to the A/D converter 26 is decreased and a resolution of the A/D converter 26 is increased, the A/D converter 26 is prevented from apply a noise to the output signal.

(Ninth Technical Feature)

The control unit 28 is configured to increase the cut-off frequency of the sub-HPF 22 in accordance with an increase in rotation speed of the turbocharger and to decrease the cut-off frequency of the sub-HPF 22 in accordance with a decrease in rotation speed of the turbocharger.

Specifically, the sub-HPF 22 includes a selector switch 31 that selects a time constant in the sub-HPF 22. The selector switch 31 executes a selection of a resistance value of the sub-HPF 22. The control unit 28 on-off controls the selector switch 31.

When the selector switch 31 is turned off and the time constant is large, the cut-off frequency of the sub-HPF 22 is referred to as a sub low fc.

When the selector switch 31 is turned off and the time constant is small, the cut-off frequency of the sub-HPF 22 is referred to as a sub high fc.

Specified values of the sub low fc and the sub high fc are not limited. However, an example for understanding will be described. According to the present embodiment, the sub low fc is set to 159 Hz, and the sub high fc is set to 1.59 kHz.

As the above description, the control unit 28 switches the cut-off frequency of the HPF 23 to three levels including a low speed region, a medium speed region and a high speed region, according to the rotation speed of the turbocharger.

In other words, the control unit 28 switches the cut-off frequency of the HPF 23 to three levels including the low fc, the medium fc and the high fc, according to the rotation speed of the turbocharger.

When the control unit 28 switches the cut-off frequency of the HPF 23 between the medium speed region and the high speed region, the control unit 28 also executes a switching of the cut-off frequency of the sub-HPF 22 at the same time by executing an on-off switching of the selector switch 31.

In other words, the control unit 28 switches the cut-off frequency of the sub-HPF 22 between the low fc and the high fc while switching the cut-off frequency of the HPF 23 between the medium fc and the high fc.

A following first table indicates a relationship between a timing of switching the cut-off frequency of the HPF 23 and a timing of switching the cut-off frequency of the sub-HPF 22.

[First table]

| rotation speed | low | medium | high |
|---|---|---|---|
| sub-HPF | sub low fc | sub medium fc | sub high fc |
| HPF | low fc | medium fc | high fc |

(Ninth Effect)

As the above description, since the cut-off frequency of the sub-HPF 22 is switched when the cut-off frequency of the HPF 23 is switched, a variation of wave amplitudes of the blade detection frequencies before and after the switching can be suppressed.

The above effect will be specifically described. As a signal S3 shown in FIG. 5, the wave amplitude of the blade detection frequency after the switching timing T of the cut-off frequency remarkably changes from the wave amplitude of the blade detection frequency before the switching timing T of the cut-off frequency. In addition, the signal S3 shown in FIG. 5 indicates a voltage waveform when the cut-off frequency is switched from the sub high fc to the sub low fc.

Since the cut-off frequency of the HPF 23 is switched when the cut-off frequency of the sub-HPF 22 is switched, a wave-amplitude variation of the blade detection frequency can be suppressed as a signal S4 shown in FIG. 5.

(Tenth Technical Feature)

When the control unit 28 switches the cut-off frequency of the HPF 23, the control unit 28 temporarily resets the HPF 23. Specifically, when the control unit 28 switches the cut-off frequency of the HPF 23, the control unit 28 temporarily transmits an average voltage value (e.g., 2V) of a signal input to the HPF 23 to a delay device Z⁻¹ in a front region of the HPF 23 and temporarily sets a calculation result of the HPF 23 to 0V (zero V). In this case, the delay device Z⁻¹ executes a signal input.

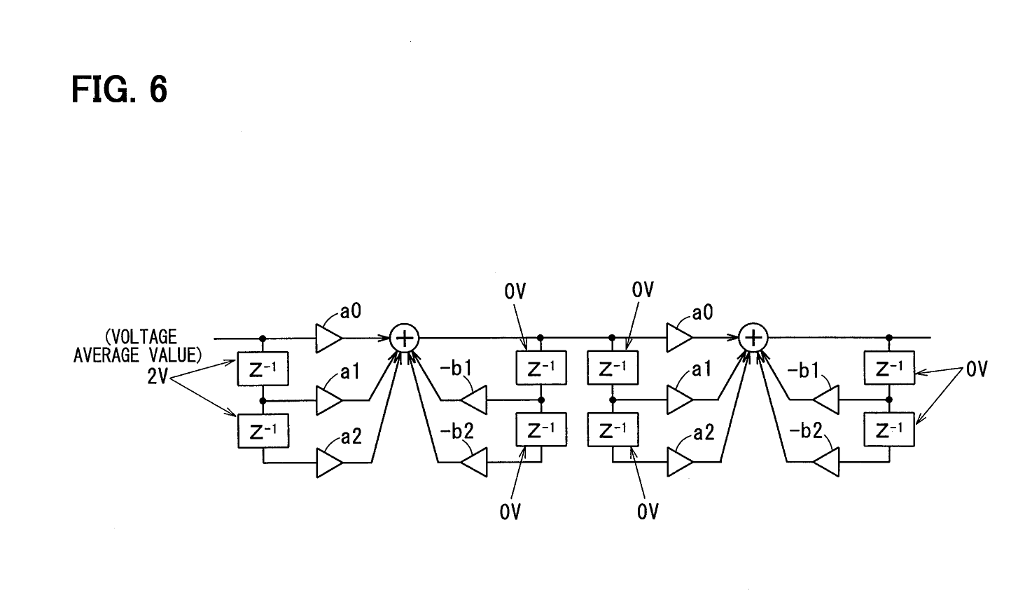

The above technical feature will be described referring to FIG. 6.

The HPF 23 shown in FIG. 6 is a four-order IIR filter constituted by two two-order IIR filters that are connected with each other in a series connection.

In addition, notations a0, a1, a2, −b1 and −b2 indicate multipliers which have filter constants that are set.

When the control unit 28 switches the cut-off frequency of the HPF 23, the control unit 28 resets a history data of the HPF 23. In this case, the control unit 28 temporarily substitutes the average voltage value to the delay devices Z⁻¹ of a feed forward of the IIR filter in a first region (left side in FIG. 6) and temporarily sets other delay devices Z⁻¹ to 0V.

(Tenth Effect)

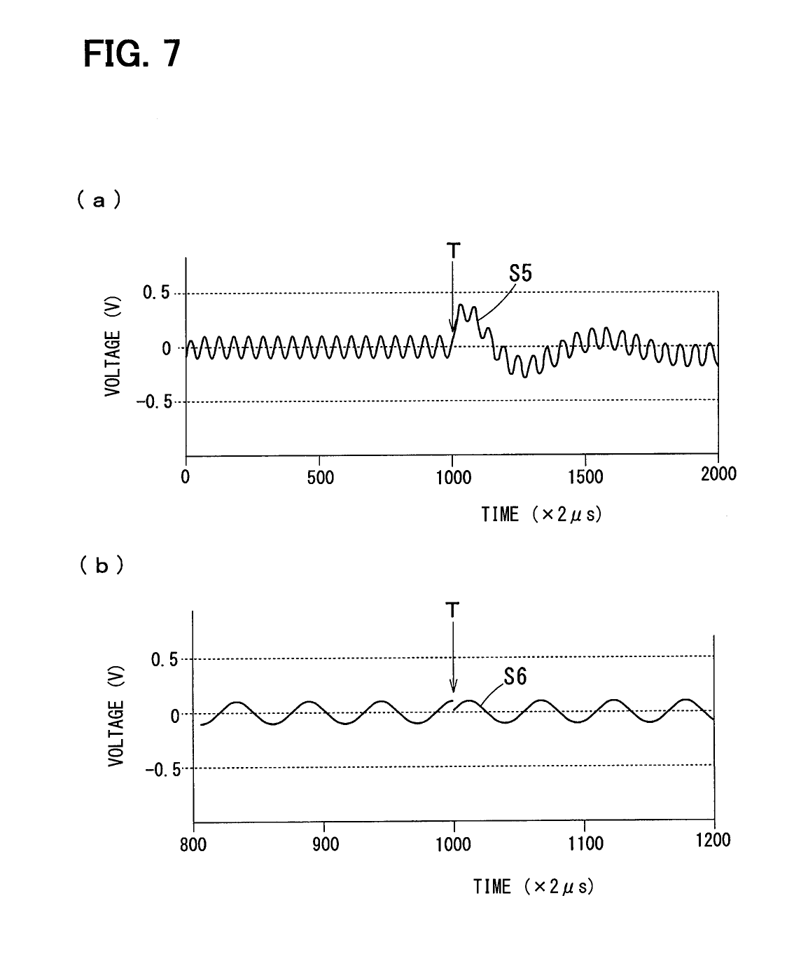

The HPF 23 using the IIR filter executes a calculation by repeatedly using the history data. Thus, when the cut-off frequency is only switched without using the tenth technical feature, a voltage of the blade detection frequency fluctuates at a cycle longer than a detection cycle of the blades 10 right after the switching of the cut-off frequency as a signal S5 shown in (a) of FIG. 7.

When the tenth technical feature is used, a malfunction that the voltage fluctuates right after the switching of the cut-off frequency can be prevented as a signal S6 shown in (b) of FIG. 7.

FIG. 7 includes (a) and (b) that are waveform graphs when the rotation speed of the turbocharger is maintained to be constant (specifically, 90,000 rpm), and (a) and (b) of FIG. 7 have indicating scales of time axes different from each other.

(Eleventh Technical Feature)

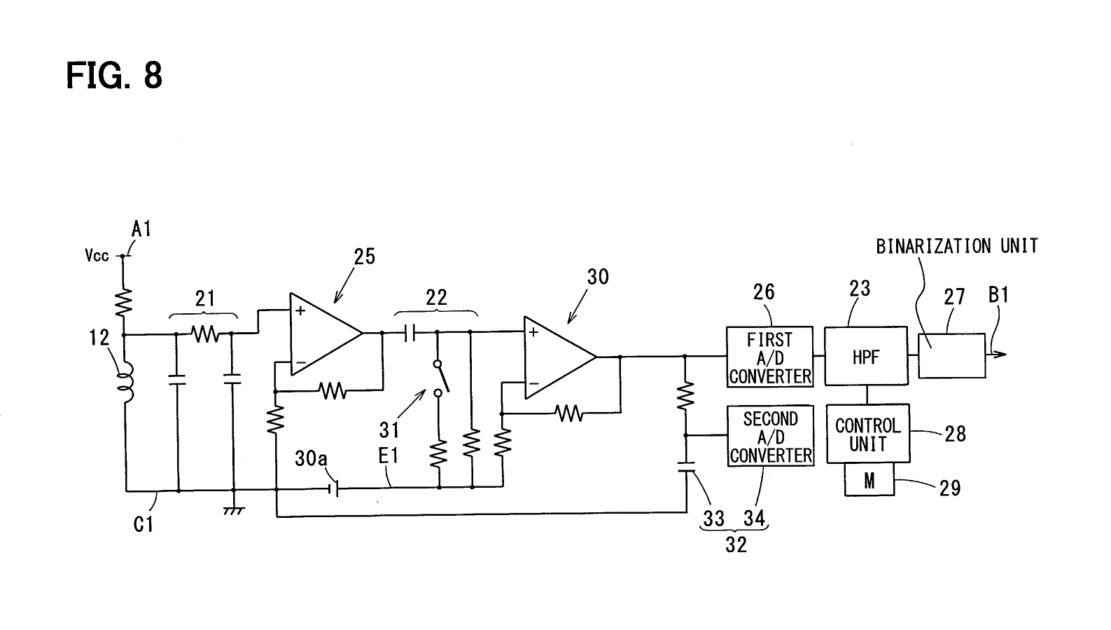

As shown in FIG. 8, the sensor circuit 13 includes an average voltage detection unit 32 that obtains the average voltage value of the signal input to the HPF 23.

The average voltage detection unit 32 loads an average voltage value of the signal input to the A/D converter 26. The average voltage detection unit 32 is constituted by a smoothing filter 33 that uses a condenser and a second A/D converter 34 that loads a voltage value that is smoothed by the smoothing filter 33. According to the present embodiment, the A/D converter 26 is referred to as a first A/D converter 26.

When the control unit 28 switched the cut-off frequency of the HPF 23, the control unit 28 transmits the average voltage value obtained by the average voltage detection unit 32 to the delay devices Z⁻¹ in the front region of the HPF 23.

(Eleventh Effect)

When the cut-off frequency of the HPF 23 is switched without using the eleventh technical feature, it is assumed that an average voltage value that is previously set is input to the delay devices Z⁻¹ in the front region of the HPF 23.

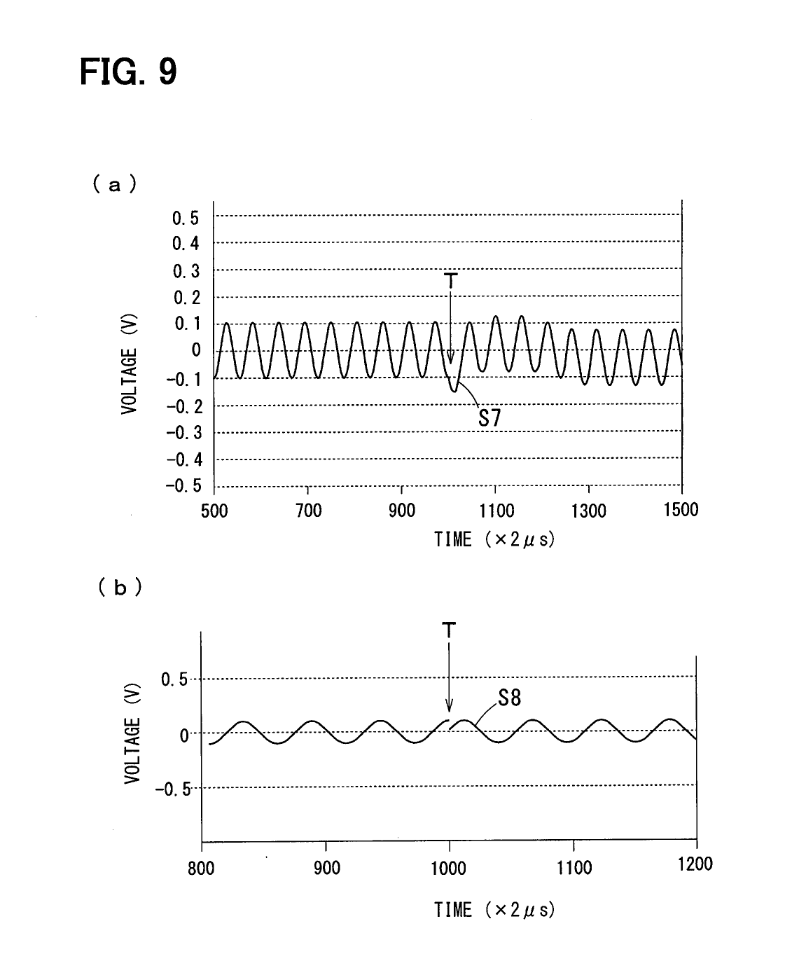

In this case, it is possible that the average voltage value that is substituted into the delay devices Z⁻¹ is different from an actual average voltage value. Then, it is possible that a voltage of the output signal of the HPF 23 fluctuates to a value in the switching of the cut-off frequency to be out of a range of the voltage before the switching, as a signal S7 shown in (a) of FIG. 9.

When the eleventh technical feature is used, the average voltage detection unit 32 can obtain an accurate average voltage value that is the voltage average value that is accurate. Thus, when the cut-off frequency of the HPF 23 is switched, the accurate average voltage value can be input to the delay devices Z⁻¹ in the front region of the HPF 23. Thus, a shift of the voltage in the switching of the cut-off frequency can be suppressed as a signal S8 shown in (b) FIG. 9.

In addition, FIG. 9 includes (a) and (b) that are waveform graphs when the rotation speed of the turbocharger is maintained to be constant (specifically, 90,000 rpm), and (a) and (b) of FIG. 9 have indicating scales of time axes different from each other.

Specifically, FIG. 9 includes (a) that is a waveform graph when 2.1V that is shifted from the actual average voltage value that is 2.0V is substituted as the average voltage value.

FIG. 9 includes (b) that is a waveform graph when 2.0V that is equal to the actual average voltage value that is 2.0V is substituted as the average voltage value.

(Twelfth Technical Feature)

A twelfth technical feature is a modification of the eleventh technical feature.

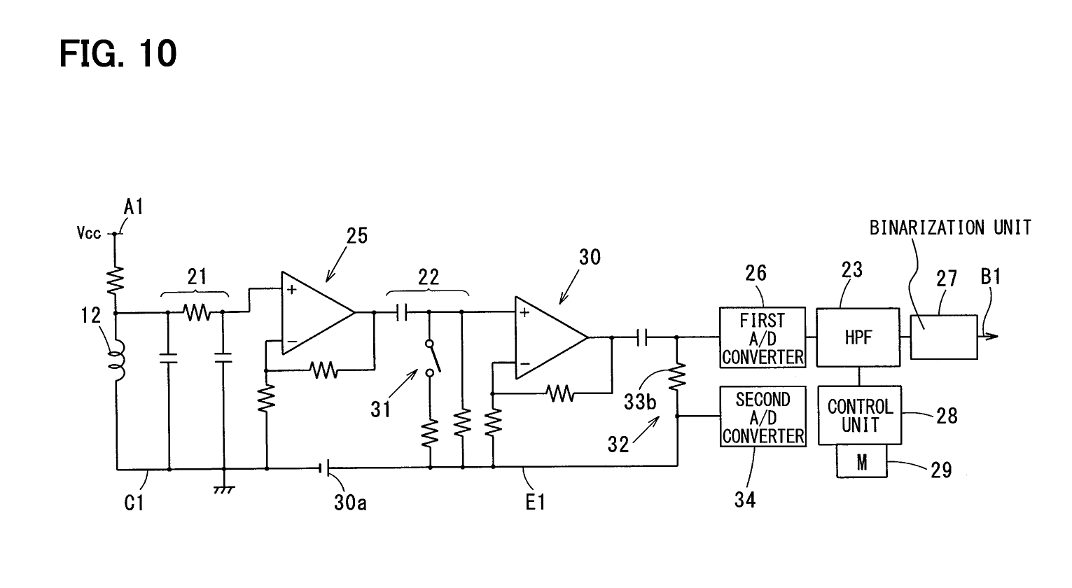

As shown in FIG. 10, the sensor circuit 13 further includes the operational amplifier 30 that amplifies the signal of the blade detection sensor 12, and the reference power source 30a. The A/D converter 26 receives the reference voltage E1 of the operational amplifier 30 while the signal of the blade detection sensor 12 and the reference voltage E1 are AC coupled by using a coupling condenser 33a and a resistor 33b.

Since an output signal of the operational amplifier 30 is biased by the reference voltage E1, the reference voltage E1 can be used as the accurate average voltage value. When the reference voltage E1 is input to the second A/D converter 34 and the cut-off frequency of the HPF 23 is switched, the reference voltage E1 received at the A/D converter 26 is input to the delay devices Z⁻¹ of the front region of the HPF 23.

(Twelfth Effect)

Since the reference voltage E1 is input to the delay devices Z⁻¹ of the front region of the HPF 23 to reset the HPF 23 when the cut-off frequency of the HPF 23 is switched, an influence of the operational amplifier 30 and an influence of a variation of the reference voltage E1 can be canceled. Thus, a malfunction that the voltage of the output signal of the HPF 23 fluctuates in the switching of the cut-off frequency can be prevented.

(Thirteenth Technical Feature)

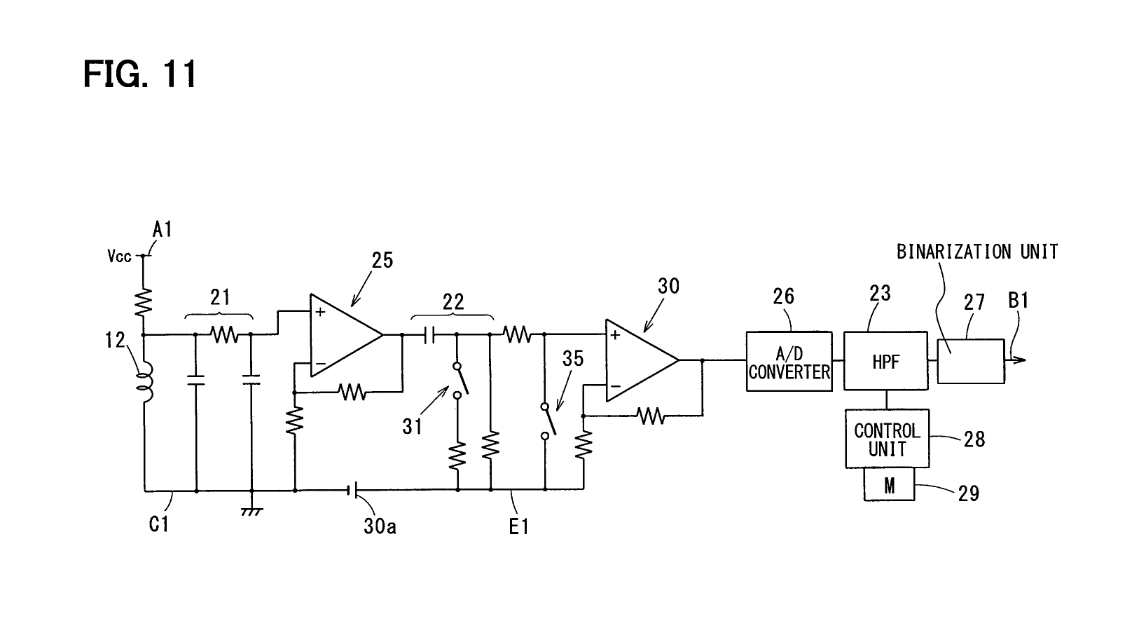

As shown in FIG. 11, the sensor circuit 13 further includes a short execution unit 35 that executes a short circuit of an output of the blade detection sensor 12.

Specifically, the short execution unit 35 is a short switch that executes a short circuit of an input of the operational amplifier 30. The control unit 28 on-off controls the short execution unit 35.

The control unit 28 temporarily turns on the short switch and measures a circuit error of the sensor circuit 13 right after the ignition switch is turned on.

The control unit 28 executes a diagnosis of the sensor circuit 13 based on a measured result of the sensor circuit 13. For example, the control unit 28 temporarily turns on the short switch and detects an error of the sensor circuit. When the control unit 28 detects the error of the sensor circuit 13, the control unit 28 is configured to correct the error.

(Thirteenth Effect)

Since the sensor circuit 13 includes the short execution unit 35, the diagnosis of the sensor circuit 13 and an error correction of the sensor circuit 13 can be executed.

(Fourteenth Technical Feature)

When the compressor wheel 7 is in the high speed rotation, it is assumed that a power supply to the sensor circuit 13 is suddenly terminated.

When the power supply to the sensor circuit 13 starts (specifically, a timing right after the ignition switch is turned on), the control unit 28 sets the cut-off frequency of the HPF 23 to a highest cut-off frequency, to deal with the above phenomenon. Specifically, according to the present embodiment, when the power supply to the sensor circuit 13 starts, the control unit 28 sets the cut-off frequency of the HPF 23 to the highest cut-off frequency that is the high fc among the low fc, the medium fc and the high fc. Then, the control unit 28 switches the cut-off frequency of the HPF 23 to a cut-off frequency according to the rotation speed of the turbocharger by a function of the first technical feature.

(Fourteenth Effect)

Since the fourteenth technical feature is used, the cut-off frequency of the HPF 23 is not set to an erroneous frequency when the power supply to the sensor circuit 13 is suddenly terminated in the high speed rotation of the compressor wheel 7. Thus, a reliability of the rotation speed detection device 11 can be improved.

(Fifteenth Technical Feature)

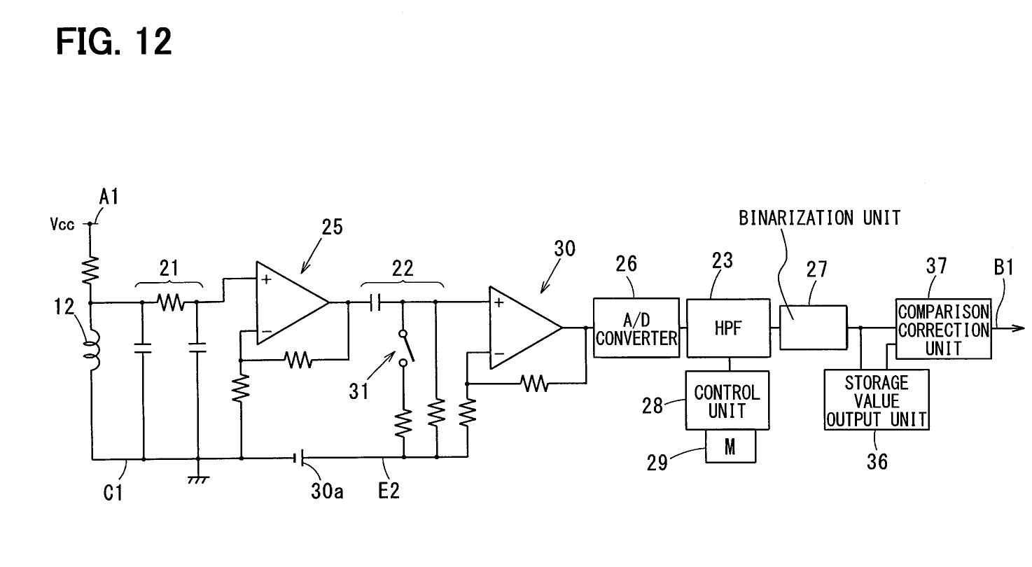

As shown in FIG. 12, the sensor circuit 13 that is a circuit preventing a high-low signal from fluctuating before and after the cut-off frequency of the HPF 23 is switched includes a storage value output unit 36 and a comparison correction unit 37 in a signal output region of the binarization unit 27. According to the present embodiment, the high-low signal includes the high signal and the low signal.

The storage value output unit 36 stores a time width (i.e., one cycle) of the high-low signal output by the binarization unit 27 before the cut-off frequency of the HPF 23 is switched.

The storage value output unit 36 repeatedly outputs the high-low signal of the time width stored before the switching, after the cut-off frequency of the HPF 23 is switched.

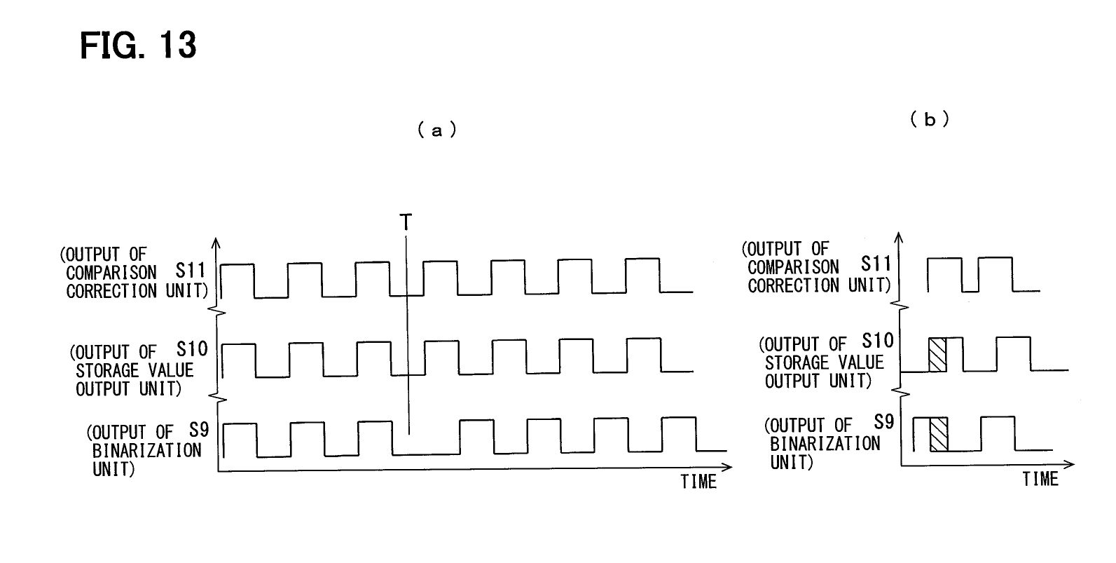

A signal S9 shown in FIG. 13 indicates an output waveform of the binarization unit 27 before and after the cut-off frequency of the HPF 23 is switched.

A signal S10 shown in FIG. 13 indicates an output waveform of the storage value output unit 36 before and after the cut-off frequency of the HPF 23 is switched.

A signal S11 shown in FIG. 13 indicates an output waveform of the comparison correction unit 37 before and after the cut-off frequency of the HPF 23 is switched.

The comparison correction unit 37 compares an output signal of the binarization unit 27 and an output signal of the storage value output unit 36, after the cut-off frequency of the HPF 23 is switched.

The comparison correction unit 37 outputs the output signal of the storage value output unit 36, until a time overlap between the high-low signal output by the binarization unit 27 and the high-low signal output by the storage value output unit 36 reaches a predetermined ratio (e.g., 50%). In other words, the comparison correction unit 37 outputs the output signal of the storage value output unit 36 as the output signal of the sensor circuit 13, in a time interval from a time point that the cut-off frequency of the HPF 23 is switched to a time point that the time overlap reaches the predetermined ratio.

A first waveform shown in (a) of FIG. 13 (i.e., a left waveform shown in FIG. 13) indicates a waveform right before the time overlap reaches the predetermined ratio.

The comparison correction unit 37 outputs the output signal of the binarization unit when the time overlap between the high-low signal output by the binarization unit 27 and the high-low signal output by the storage value output unit 36 reaches the predetermined ratio. In other words, the comparison correction unit 37 outputs the output signal of the binarization unit 27 as the output signal of the sensor circuit 13, after the time overlap reaches the predetermined ratio when the cut-off frequency of the HPF 23 is switched.

A second waveform shown in (b) of FIG. 13 (i.e., a right waveform shown in FIG. 13) indicates a waveform right after the time overlap reaches the predetermined ratio.

(Fifteenth Effect)

As the above description, a malfunction that a toothless of a waveform of the output signal of the sensor circuit 13 is generated or a chattering of the output signal of the sensor circuit 13 is generated can be prevented, right after the cut-off frequency of the HPF 23 is switched. In other words, a malfunction that the high-low signal fluctuates can be prevented in the switching of the cut-off frequency of the HPF 23.

(Sixteenth Technical Feature)

The storage value output unit 36 is configured to always store a latest value of the time width of the high-low signal that is binarized by the binarization unit 27. Specifically, the storage value output unit 36 is configured to always update an average value (i.e., average cycle) of the time width of the high-low signal. When a total number of sampling waveforms is small in a case where the average value is obtained, an error becomes large. In contrast, when the total number of the sampling waveforms is large, a rotation change of the compressor wheel 7 cannot be followed.

The time width of the high-low signal stored in the storage value output unit 36 uses an average value of one rotation of the compressor wheel 7 or an average value of several rotations of the compressor wheel 7. According to the present embodiment, several rotations may be equivalent to rotations less than ten times.

(Sixteenth Effect)

Since the average of the time width of the high-low signal is obtained from a waveform of one rotation of the compressor wheel 7 or a waveform of several rotations of the compressor wheel 7, an accuracy of the time width of the high-low signal at the switching timing T can be improved.

### Second Embodiment

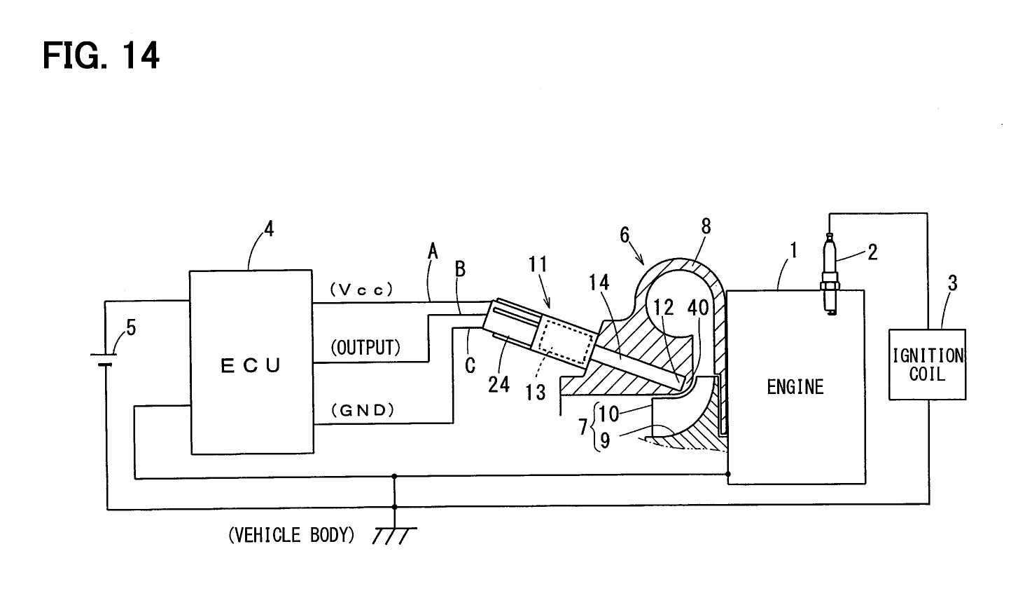

Referring to FIG. 14, a second embodiment of the present disclosure will be described. In addition, the substantially same parts or components as those in the first embodiment are indicated with the same reference numerals. Hereafter, only changed matters relative to the first embodiment will be detailed, and parts or components which are not described are the same as those in prior embodiment.

According to the second embodiment, a wall 40 is interposed between the blade detection sensor 12 and the compressor wheel 7.

The wall 40 is constituted by a part of the compressor housing 8.

Specifically, an insertion hole in the compressor housing 8 into which the probe 14 is inserted has a bottom such that the insertion hole does not penetrate through the compressor housing 8 to reach an interior of the compressor housing 8. Then, the wall 40 constituted by a part of the compressor housing 8 is located at a position between the bottom of the insertion hole and an inner surface of the compressor housing 8.

The wall 40 attenuates the high frequency component of the output signal of the blade detection sensor 12. Specifically, an attenuation effect of the high frequency component increases in accordance with an increase in thickness of the wall 40 and decreases in accordance with a decrease in thickness of the wall 40. The thickness of the wall 40 is set to obtain a proper attenuation effect.

According to the second embodiment, the rotation speed detection device 11 cuts off the high frequency component by the wall 40. Thus, the shaft shift remarkably appears, and the effects of the first embodiment can be further achieved.

The wall 40 can suppress a temperature increasing of the blade detection sensor 12. Thus, a long term reliability of the blade detection sensor 12 can be improved, and accordingly the reliability of the rotation speed detection device 11 can be improved.

Other effects of the rotation speed detection device 11 according to the second embodiment are the same as those of the rotation speed detection device 11 according to the first embodiment, the descriptions are omitted.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

1. A rotation speed detection device comprising:
a blade detection sensor located in a housing of an intake gas compressor of a turbocharger that compresses an intake gas and supplies the intake gas to an engine for a vehicle travelling, the blade detection sensor to output an output voltage that fluctuates according to an approaching of a blade of a compressor wheel that rotates in the housing to the blade detection sensor and a separation of the blade from the blade detection sensor;
a sensor circuit to binarize an output signal of the blade detection sensor into a high signal and a low signal and to output the high signal and the low signal, wherein
the sensor circuit includes
a low pass filter to cut off a high frequency component of the output signal of the blade detection sensor by an analog filter or a digital filter,
a high pass filter to cut off a low frequency component of the output signal of the blade detection sensor by a digital filter, and
a control unit to increase a cut-off frequency of the high pass filter in accordance with an increase in rotation speed of the turbocharger and to decrease the cut-off frequency of the high pass filter in accordance with a decrease in rotation speed of the turbocharger.

2. The rotation speed detection device according to claim 1, wherein
the control unit sets a hysteresis of a switching timing of the cut-off frequency relative to the rotation speed of the turbocharger.

3. The rotation speed detection device according to claim 1, further comprising:
a wall constituted by the housing and interposed between the blade detection sensor and the compressor wheel.

4. The rotation speed detection device according to claim 1, wherein
when an upper limit of the rotation speed of the turbocharger in a coverage of a predetermined cut-off frequency relative to the rotation speed of the turbocharger is expressed as an upper-limit rotation speed,
a lower limit of the rotation speed of the turbocharger in the coverage of the predetermined cut-off frequency relative to the rotation speed of the turbocharger is expressed as a lower-limit rotation speed,
a frequency that is twice as a frequency corresponding to the rotation speed of the turbocharger at the upper-limit rotation speed is expressed as an upper-limit frequency,
an output frequency of the blade detection sensor at the lower-limit rotation speed is expressed as a lower-limit frequency, and
the predetermined cut-off frequency is set to a frequency between the upper-limit frequency and the lower-limit frequency.

5. The rotation speed detection device according to claim 1, wherein
the control unit has a blade-number processing function that increases the cut-off frequency of the high pass filter in accordance with an increase in total number of blades input from an external.

6. The rotation speed detection device according to claim 5, wherein
the control unit includes a nonvolatile memory, and
the nonvolatile memory stores a relationship between the total number of the blades and the cut-off frequency.

7. The rotation speed detection device according to claim 1, wherein
the high pass filter is an infinite impulse response filter.

8. The rotation speed detection device according to claim 1, wherein
the sensor circuit further includes an earth line that is electrically separated from the engine and a vehicle body provided with the engine.

9. The rotation speed detection device according to claim 1, wherein
the sensor circuit further includes a sub high pass filter to cut off a low frequency component of the output signal of the blade detection sensor by an analog filter,
a cut-off frequency of the sub high pass filter is set to be lower than the cut-off frequency of the high pass filter, and
the control unit increases the cut-off frequency of the sub high pass filter in accordance with an increase in rotation speed of the turbocharger and decreases the cut-off frequency of the sub high pass filter in accordance with a decrease in rotation speed of the turbocharger.

10. The rotation speed detection device according to claim 9, wherein
the control unit switches the cut-off frequency of the high pass filter to three levels including a low speed region, a medium speed region and a high speed region, according to the rotation speed of the turbocharger, and
when the control unit switches the cut-off frequency of the high pass filter between the medium speed region and the high speed region, the control unit executes a switching of the cut-off frequency of the sub high pass filter.

11. The rotation speed detection device according to claim 1, wherein
when the control unit switches the cut-off frequency of the high pass filter, the control unit temporarily transmits an average voltage value of a signal input to the high pass filter to a delay device in a front region of the high pass filter and temporarily sets a calculation result of the high pass filter to zero.

12. The rotation speed detection device according to claim 11, wherein
the sensor circuit further includes an average voltage detection unit to obtain the average voltage value of the signal input to the high pass filter, and
when the control unit switches the cut-off frequency of the high pass filter, the control unit transmits the average voltage value obtained by the average voltage detection unit to the delay device of the front region of the high pass filter.

13. The rotation speed detection device according to claim 11, wherein
the sensor circuit further includes an operational amplifier to amplify the signal of the blade detection sensor and a reference power source to output a reference voltage of the operational amplifier, and
when the control unit switches the cut-off frequency of the high pass filter, the control unit transmits the reference voltage output by the reference power source to the delay device of the front region of the high pass filter.

14. The rotation speed detection device according to claim 1, wherein
the sensor circuit further includes a short execution unit to execute a short circuit of the output signal of the blade detection sensor.

15. The rotation speed detection device according to claim 1, wherein
when a power supply to the sensor circuit starts, the control unit sets the cut-off frequency of the high pass filter to a highest cut-off frequency.

16. The rotation speed detection device according to claim 1, wherein
the sensor circuit further includes
a binarization unit to binarize the output signal of the high pass filter into a high signal and a low signal,
a storage value output unit to store a time width of a high-low signal that includes the high signal and the low signal and is output by the binarization unit before the cut-off frequency of the high pass filter is switched, and the storage value output unit to repeatedly output the high-low signal of the time width stored before a switching of the cut-off frequency after the cut-off frequency of the high pass filter is switched, and
a comparison correction unit to compare an output signal of the binarization unit with an output signal of the store value output unit after the cut-off frequency of the high pass filter is switched, and the comparison correction unit to switch an output signal of the sensor circuit from the output signal of the storage value output unit to the output signal of the binarization unit when an overlap between the high-low signal output by the binarization unit and the high-low signal output by the storage value output unit reaches a predetermined ratio.

17. The rotation speed detection device according to claim 16, wherein
the time width of the high-low signal stored in the storage value output unit is an average value of one rotation of the compressor wheel or an average value of several rotations of the compressor wheel.
